(19) United States
(12) Patent Application Publication
(10) Pub. No.: US 2026/0118201 A1
(43) Pub. Date: Apr. 30, 2026

(54) LEAK SENSING CONNECTION POINT COLLAR

(71) Applicant: DELL PRODUCTS L.P., Round Rock, TX (US)

(72) Inventor: Owen Kidd, Cedar Park, TX (US)

(21) Appl. No.: 18/926,754

(22) Filed: Oct. 25, 2024

(51) Int. Cl. G01M 3/18

(52) U.S. Cl. CPC G01M 3/183; F28F 2265/16

(57) ABSTRACT

A leak detection system includes a leak detection circuit and a connector collar. The connector collar is configured to couple a first element of a liquid cooling system to a second element of the liquid cooling system, and to provide an electrical input to the leak detection circuit in the presence of a coolant liquid leak from the connector collar.

### FIELD OF THE DISCLOSURE

This disclosure relates to information handling systems, and more particularly relates to a leak sensing connection point collar in a direct liquid cooling system for an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A leak detection system may include a leak detection circuit and a connector collar. The connector collar may be configured to couple a first element of a liquid cooling system to a second element of the liquid cooling system, and may provide an electrical input to the leak detection circuit in the presence of a coolant liquid leak from the connector collar.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a direct liquid cooling (DLC) system according to an embodiment of the present disclosure;

FIGS. 2A and 2B are cross-sectional views of a coolant liquid connector assembly according to an embodiment of the present disclosure;

FIGS. 3A and 3B are cross-sectional views of a coolant liquid connector assembly according to another embodiment of the present disclosure;

FIGS. 4A and 4B are cross-sectional views of a coolant liquid connector assembly according to another embodiment of the present disclosure; and

FIG. 5 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

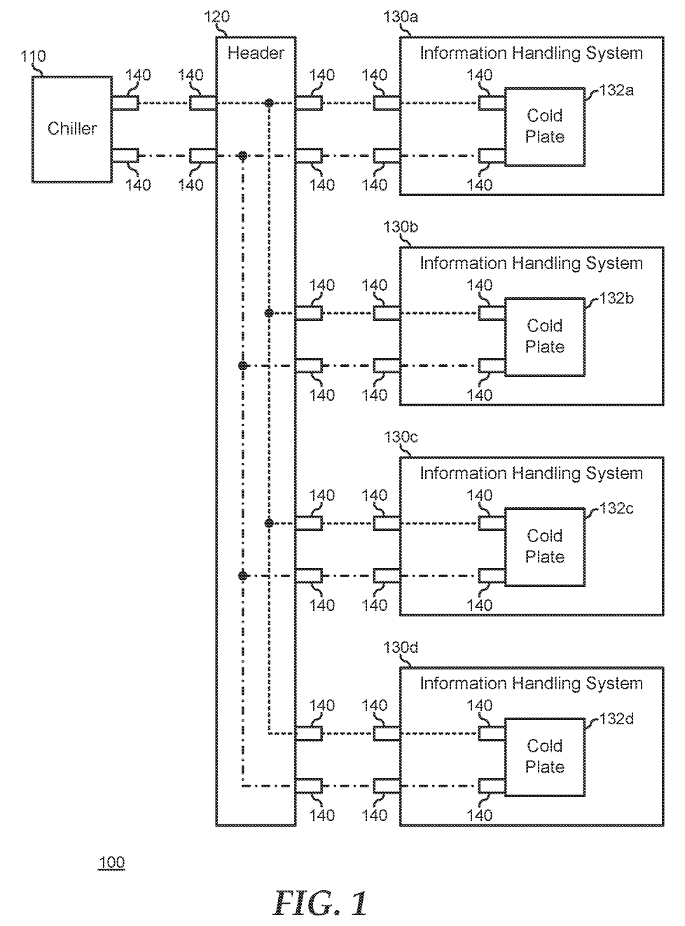

FIG. 1 illustrates a direct liquid cooling (DLC) system 100. DLC system 100 provides cooling for critical components within information handling systems, for example in a data center or other high-density computing environment. DLC system 100 includes a chiller 110, a header 120 and a number of information handling systems 130a-d. Each one of information handling systems 130a-d include one or more components that generate large amounts of heat in the enclosure of their respective information handling systems. For example information handling systems 130a-d may include one or more processors (CPUs), chipset components, graphics processing units (GPUs), memory devices, storage devices, or the like, that represent a large portion of the thermal load of the respective information handling systems.

In order to remove the heat generated in an information handling system, manufacturers and users are turning to DLC systems like DLC system 100 to more efficiently and effectively manage the heat generated within their information handling systems and data centers. In this regard, information handling systems 130a-d each include one or more cold plate 132a-d to remove the heat from the high-heat generating components. As such, chiller 110 operates to supply chilled coolant liquid (as illustrated by the dotted lines) to header 120. Header 120 includes a cold manifold that distributes the chilled coolant liquid to each of cold plates 132a-d. Cold plates 132a-d are configured to be thermally connected to the high-heat generating components, where the heat from the components is thermally transferred to the coolant liquid. The heated coolant liquid (indicated by the doted/dashed lines) is returned from cold plates 132a-d to header 120 where a cold manifold combines the heated coolant liquid for return to chiller 110. In this regard, DLC system 100 is a closed-loop system, rechilling the coolant liquid for redistribution throughout the DLC system.

DLC system 100 is characterized by the need to connect the components together to move the coolant liquid throughout the DLC system. In particular, each component (e.g., chiller 110, header 120, and cold plates 132a-d includes couplers 140 that couple the respective component to tubing that spans the distance between the respective components. DLC systems similar to DLC system 100 are prone to develop liquid coolant leaks. This presents a particular hazard when a leak develops within the enclosure of information handling systems 130a-d, where sensitive electronic components can be damaged, for example, when the liquid coolant bridges electrical circuits creating short circuits. Various mechanisms for mitigating liquid coolant leaks may include the application of highly absorbent material on the printed circuit boards (PCBs) of the information handling system, leak detection mechanisms such as leak detection ropes and the like, and the consequent shutting down of the information handling system when a liquid coolant leak is detected. It has been understood by the inventors of the current disclosure that couplers such as couplers 140 are more prone to develop liquid coolant leaks than are the components and tubing that are connected by the couplers.

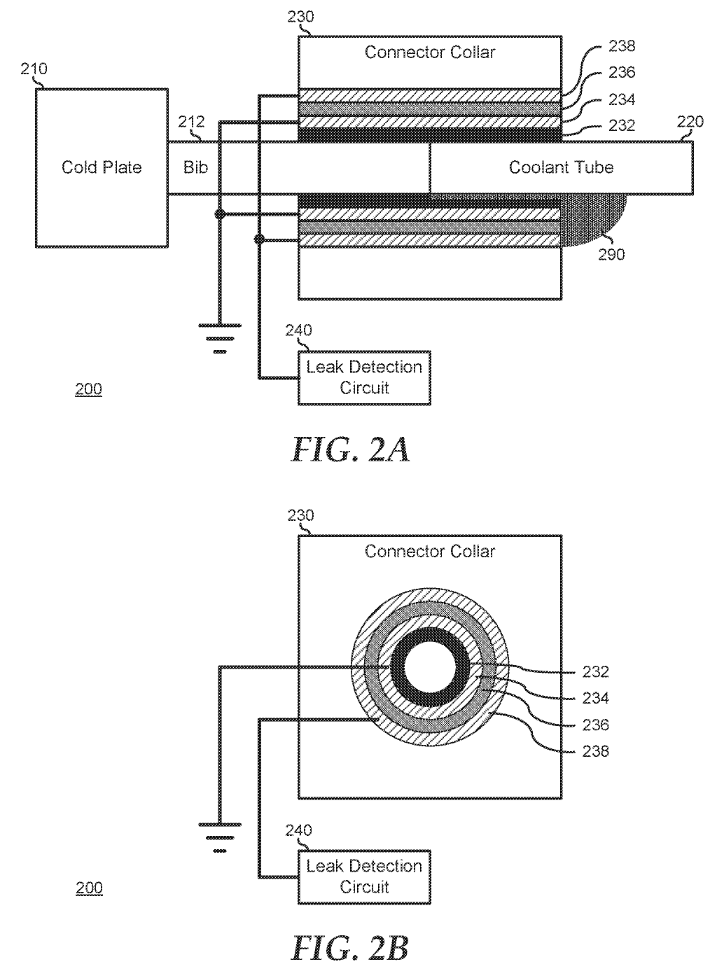

FIGS. 2A and 2B illustrate cross-sectional views of a coolant liquid connector assembly 200 (hereinafter “assembly 200”). Assembly 200 includes a cold plate 210, a coolant tube 220, a connector collar 230, and a leak detection circuit 240. Cold plate 210 and coolant tube 220 are illustrative of any kind of component of a DLC system that are to be connected together by a connector, and the cold plate and the coolant tube may thus be substituted for any other type of DLC system component, as needed or desired, and such other types of components to be connected together by a connector collar will be understood to be usable in the context of the current disclosure. Cold plate 210 includes a connection bib 212 that is configured to mate to one side of connector collar 230, such as where the connection bib and the connector collar are provided with complimentary thread, are configure to be crimped together, are provided as complimentary elements of a compression-type connector, are soldered or welded together, are glued together, or the like. Similarly, coolant tube 220 is configured to mate to the opposite side of connector collar 230 by any type of connector mating, as needed or desired. Connector collar 230 is thus configured to join cold plate 210 (via bib 212) to coolant tube 220, and to provide a leak-tight connection between the cold plate and the coolant tube.

Connector collar 230 includes a connector wall 232, a first metal contact 234, an isolator 236, and a second metal contact 238. Connector wall 232 represents a surface to engage with bib 212 and with coolant tube 220 to physically retain the bib and the coolant tube, and to seal the connection between the bib and the coolant tube. As such, connector wall 232 may be understood to provide complimentary mating surfaces for bib 212 and coolant tube 220, as described above. Connector wall 232 also operates to electrically insulate any leaked coolant liquid from metal contacts 234 and 238, as described further below. As shown in FIG. 2B, connector wall 232 is situated concentrically surrounding bib 212 and coolant tube 220. Further, metal contact 234 is situated concentrically surrounding connector wall 232, isolator 236 is situated concentrically surrounding metal contact 234, and metal contact 238 is situated concentrically surrounding isolator 236.

Leak detection circuit 240 operates to provide a voltage or other detection signal to metal contact 238. Metal contact 234 is connected to a circuit ground, and, when no leak is present, isolator 236 acts as an insulator between the metal contacts. As such, leak detection circuit 240 senses the provided voltage or detection signal on metal contact 238. However in the presence of a coolant liquid leak 290, the coolant liquid comes into electrical contact with metal contact 234, and as the leak grows, surmounts isolator 236 to come into electrical contact with metal contact 238, thereby electrically bridging the gap between the electrical contacts. In this way, the voltage or other detection signal provide by leak detection circuit 240 is grounded via the coolant liquid, thereby decreasing the voltage level or otherwise attenuating the detection signal. This voltage decrease or attenuation is then sensed by leak detection circuit 240.

The elements of assembly 200 are not necessarily shown to scale. In particular, metal contacts 234 and 238 and isolator 236 may be thin in order to necessitate only a small amount of coolant liquid to bridge between the metal contacts in order to detect leak 290. For example, metal contacts 234 and 238 may be fabricated utilizing a metallic foil or the like. Moreover, isolator 236 may be perforated, or otherwise configured such that the isolator provides a capillary action to the coolant liquid to accelerate the bridging of the coolant liquid between metal contacts 234 and 238 to detect leak 290. Note that connector collar 230 is illustrated as providing leak detection both at bib 212 and at coolant tube 220, but this is not necessarily so. For example, a connector collar can be fabricated integrally with another element as a single attachable element. Here, only one side may need to have the leak detection capabilities as described above. Further, note that the signal connections may be swapped, such that voltage or detection signal may be connected to metal contact 234, and metal contact 238 may be connected to the circuit ground, as needed or desired.

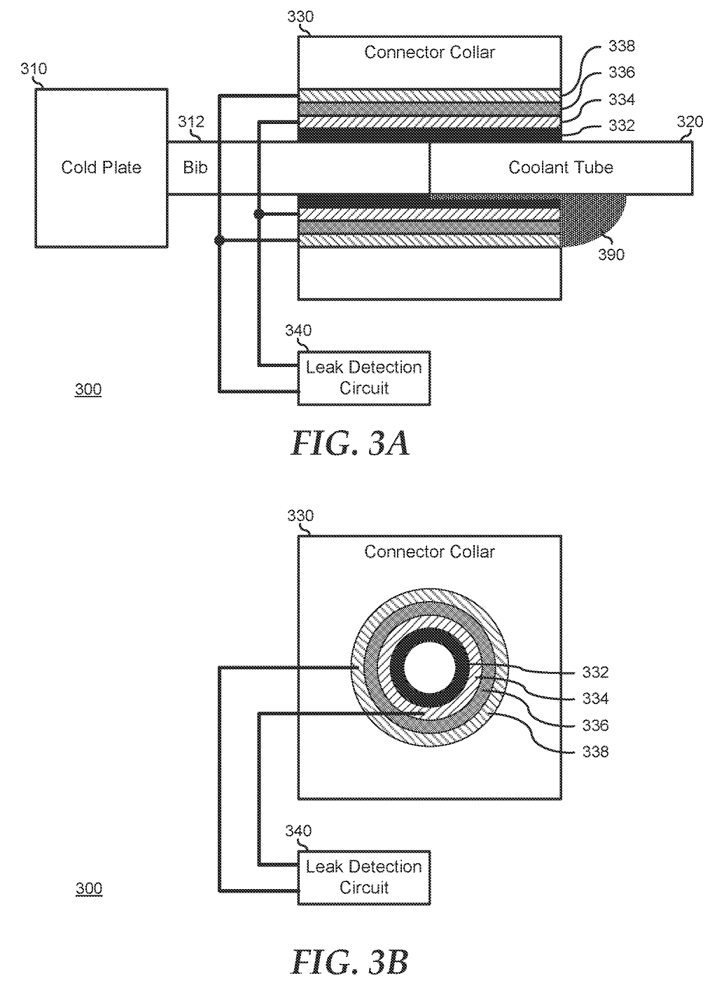

FIGS. 3A and 3B show a coolant liquid connector assembly 300 (hereinafter “assembly 300”) similar to assembly 200. Assembly 300 includes a cold plate 310 similar to cold plate 210, a coolant tube 320 similar to coolant tube 220, a connector collar 330 similar to connector collar 230, and a leak detection circuit 340 similar to leak detection circuit 240. As noted similarly above, cold plate 310 and coolant tube 320 are illustrative of any kind of component of a DLC system that are to be connected together by a connector. Cold plate 310 includes a connection bib 312 that is configured to mate to one side of connector collar 330, and coolant tube 320 is configured to mate to the opposite side of the connector collar. Connector collar 330 is thus configured to join cold plate 310 (via bib 312) to coolant tube 320, and to provide a leak-tight connection between the cold plate and the coolant tube.

Connector collar 330 includes a connector wall 332, a first metal contact 334, an isolator 336, and a second metal contact 338. Connector wall 332 represents a surface to engage with bib 312 and with coolant tube 320 to physically retain the bib and the coolant tube, and to seal the connection between the bib and the coolant tube. As such, connector wall 332 may be understood to provide complimentary mating surfaces for bib 312 and coolant tube 320, as described above. Connector wall 332 also operates to electrically insulate any leaked coolant liquid from metal contacts 334 and 338, as described further below. As shown in FIG. 3B, connector wall 332 is situated concentrically surrounding bib 312 and coolant tube 320. Further, metal contact 334 is situated concentrically surrounding connector wall 332, isolator 336 is situated concentrically surrounding metal contact 334, and metal contact 338 is situated concentrically surrounding isolator 336.

Leak detection circuit 340 operates to detect a voltage between metal contacts 334 and 338. As such, metal contact 334 is connected to a first input of leak detection circuit 340, and metal contact 334 and metal contact 338 are formed of dissimilar metals. Metal contact 338 is connected to a second input of the leak detection circuit. When no leak is present, isolator 336 acts as an insulator between metal contact 334 and metal contact 338, and no voltage is presented between the metal contacts. However, in the presence of a coolant liquid leak 390, the coolant liquid will be understood to come into electrical contact with metal contact 334, and, as the leak grows, to surmount isolator 336 to come into electrical contact with metal contact 338, thereby electrically bridging the gap between the electrical contacts. Because metal contact 334 is formed of a different material than metal contact 338, a galvanic potential is created between the metal contacts, and the resulting voltage is sensed by leak detection circuit 340. Metal contact 334 and metal contact 338 may be formed utilizing a variety of metals. For example, utilizing copper and magnesium may result in a leak detection voltage of 2.7V in ideal conditions, with a likely leak detection voltage around 1V being likely for typical conditions. In a case where a higher current, or broader, loop-level detection, is required, a connector collar similar to connector collar 330 may be formed where an anode is located anywhere inside the liquid loop and a dissimilar metallic paint or other coating is applied strategically on the outside of the liquid loop.

The elements of coolant liquid connector assembly 300 are not necessarily shown to scale. In particular, metal contacts 334 and 338 and isolator 336 may be thin in order to necessitate only a small amount of coolant liquid to bridge between the metal contacts in order to detect leak 390. For example, metal contacts 334 and 338 may be fabricated utilizing a metallic foil or the like. Moreover, isolator 336 may be perforated, or otherwise configured such that the isolator provides a capillary action to the coolant liquid to accelerate the bridging of the coolant liquid between metal contacts 334 and 338 to detect leak 390. Connector collar 330 is illustrated as providing leak detection both at bib 312 and at coolant tube 320, but this is not necessarily so. For example, a connector collar can be fabricated integrally with another element as a single attachable element. Here, only one side may need to have the leak detection capabilities as described above.

The particulars of assembly 200 and assembly 300 provide for leak detection at a single point (that is, at respective connector collar 230 or connector collar 240). In order to provide leak detection for multiple connector collars, it may be envisioned that multiple leak detection circuits may be needed. In this way, a leak can be quickly localized based upon which leak detection circuit detects the leak. However, such a solution may necessitate a large number of electrical wiring and I/O devices. Thus in another case, multiple connector collars may be connected together to form a leak detection network, as needed or desired. For example, multiple connector collars may be provided with a common input signal from a single leak detection circuit, or the galvanic voltage from multiple connector collars may be provided to a single leak detection circuit, as needed or desired.

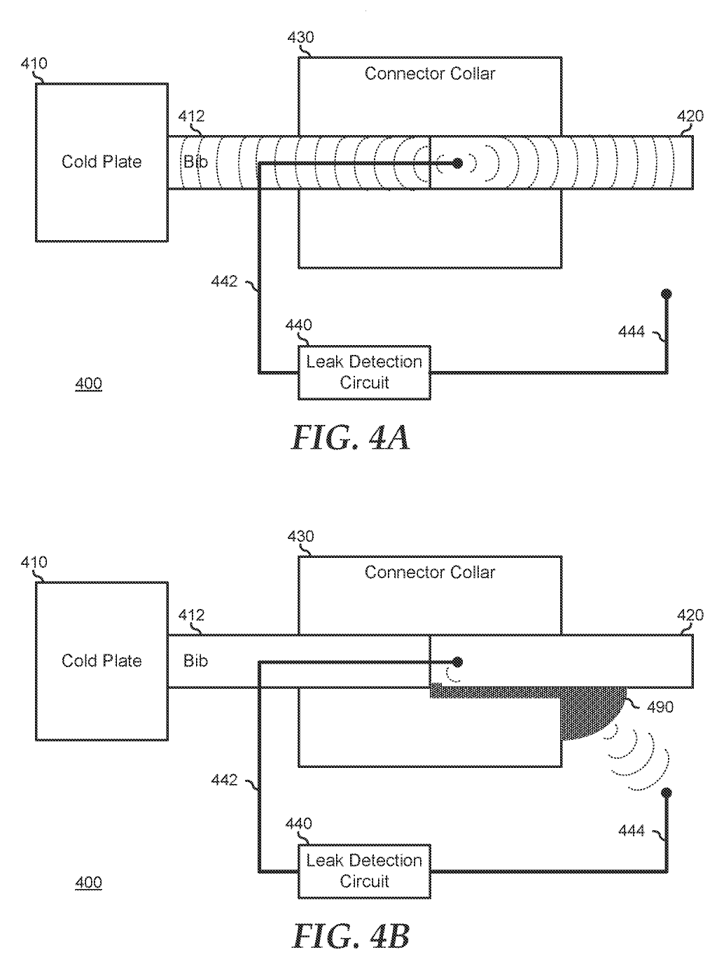

FIGS. 4A and 4B show a coolant liquid connector assembly 400 (hereinafter “assembly 400”) similar to assemblies 200 and 300. Assembly 400 includes a cold plate 410 similar to cold plates 210 and 310, a coolant tube 420 similar to coolant tubes 220 and 320, a connector collar 430 similar to connector collars 230 and 330, and a leak detection circuit 440 similar to leak detection circuits 240 and 340. As noted similarly above, cold plate 410 and coolant tube 420 are illustrative of any kind of component of a DLC system that are to be connected together by a connector. Cold plate 410 includes a connection bib 412 that is configured to mate to one side of connector collar 430, and coolant tube 420 is configured to mate to the opposite side of the connector collar. Connector collar 430 is thus configured to join cold plate 410 (via bib 412) to coolant tube 420, and to provide a leak-tight connection between the cold plate and the coolant tube.

Cold plate 410, bib 412, coolant tube 420, connector collar 430, and other elements of the coolant liquid loop are provided with a shielding layer that electrically shields the coolant liquid. The shielding layer may be provided based upon the material of the associated elements. For example, cold plate 410 and bib 412 may be fabricated of a metal material that would thereby act to shield the coolant liquid flowing therein. Further, the shielding layer may be provided by including additional structures in the elements. For example, coolant tube 420 may be fabricated with a metallic shield layer, such as an aluminum foil layer in the wall of the coolant tube or may be lined with a metallic layer to provide the shielding.

Leak detection circuit 440 includes a signal source antenna 442 and a signal receiver antenna 444. Signal source antenna 442 is connected to a signal output of leak detection circuit 440 and is inserted into the coolant liquid loop in the flow of the coolant liquid. The signal output of leak detection circuit 440 is configured to provide an input signal on signal source antenna 442 that radiates throughout the coolant liquid loop, as illustrated in FIG. 4A. Here, because of the shielding layer, the input signal is contained within the coolant liquid loop. The input signal may be understood to represent a short wavelength (high frequency) signal, as described further below. The strength of the input signal may be provided at a level that assures that the signal is maintained throughout the coolant liquid loop without excessive attenuation.

FIG. 4B illustrates where connector collar 420 exhibits a leak 490 of the coolant liquid. Here, because the input signal is a short wavelength signal, a small path of leaked coolant liquid permits the input signal to propagate to the exterior of the coolant liquid loop, and to radiate into free air in the system. This radiated signal is detected by signal receiver antenna 444, and the leaking coolant liquid is thereby detected. Here, leak detection circuit 440 may be configured to provide a signal level detection function, such that a detection at a low signal strength may be assumed to be associated with imperfect shielding of the coolant liquid loop, while a high signal strength may be associated with a leak event. Note that, due to the broadcast nature of the signal when a leak event occurs, leak detection circuit 440 operates to provide leak detection for a large area, because any leaking component will provide a signal path for the input signal to be radiated to signal receiver antenna 444.

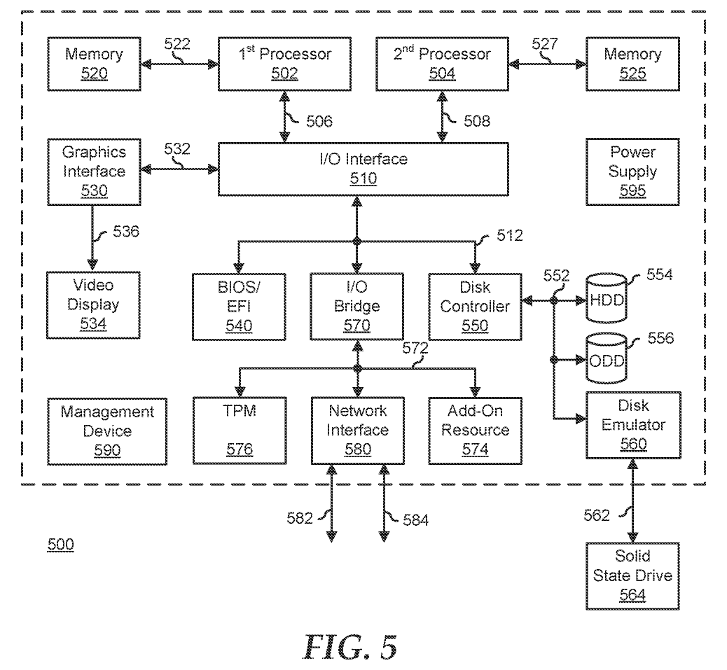

FIG. 5 illustrates a generalized embodiment of an information handling system 500 similar to information handling system 500. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below, and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556 , a disk emulator 560 connected to an external solid state drive (SSD) 562, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556 , disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532, and provides a video display output 536 to a video display 534. In a particular embodiment, information handling system 500 includes separate memories that are dedicated to each of processors 502 and 504 via separate memory interfaces. An example of memories 520 and 530 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 1394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512, or can be a different type of interface. As such, I/O bridge 570 extends the capacity of I/O channel 512 where peripheral interface 572 and the I/O channel are of the same type, and the I/O bridge translates information from a format suitable to the I/O channel to a format suitable to the peripheral channel 572 where they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500. Management device 590 can operate off of a separate power plane from the components of the host environment so that the management device receives power to manage information handling system 500 where the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A leak detection system, comprising:
a leak detection circuit; and
a connector collar configured to couple a first element of a liquid cooling system to a second element of the liquid cooling system, and to provide an electrical input to the leak detection circuit in the presence of a coolant liquid leak from the connector collar.

2. The leak detection system of claim 1, wherein the connector collar includes an inner wall configured to seal the coolant liquid from leaking.

3. The leak detection system of claim 2, wherein the connector collar further includes a first metal contact surrounding the inner wall, an isolator surrounding the first metal contact, and a second metal contact surrounding the isolator.

4. The leak detection circuit of claim 3, wherein the presence of the coolant liquid electrically couples the first metal contact to the second contact.

5. The leak detection system of claim 4, wherein the first metal contact is coupled to the leak detection circuit and the second metal contact is coupled to a ground plane.

6. The leak detection system of claim 5, wherein the leak detection circuit provides a detection signal to the to the first metal contact.

7. The leak detection system of claim 4, wherein the first metal contact is coupled to a first input of the leak detection circuit and the second metal contact is coupled to a second input of the leak detection circuit.

8. The leak detection system of claim 7, wherein the first metal contact is formed of a different material then the second metal contact.

9. The leak detection system of claim 8, wherein the presence of the coolant liquid creates a galvanic potential between the first metal contact and the second metal contact that is detected by the leak detection circuit.

10. The leak detection system of claim 3, wherein the isolator is configured, when dry, to electrically insulate the first metal contact from the second metal contact.

11. A method, comprising:
providing, in a leak detection system, a leak detection circuit;
providing, in the leak detection system, a connector collar configured to couple a first element of a liquid cooling system to a second element of the liquid cooling system; and
providing, by the connector collar, an electrical input to the leak detection circuit in the presence of a coolant liquid leak from the connector collar.

12. The method of claim 11 further comprising providing, in the connector collar, an inner wall configured to seal the coolant liquid from leaking.

13. The method of claim 12, further comprising:
providing, in the connector collar, a first metal contact surrounding the inner wall;
providing an isolator surrounding the first metal contact; and
providing a second metal contact surrounding the isolator.

14. The method of claim 13, wherein the presence of the coolant liquid electrically couples the first metal contact to the second contact.

15. The method of claim 14, further comprising:
coupling the first metal contact to the leak detection circuit; and
coupling the second metal contact to a ground plane.

16. The method of claim 15, wherein the leak detection circuit provides a detection signal to the to the first metal contact.

17. The method of claim 14, further comprising:
coupling the first metal contact to a first input of the leak detection circuit; and
coupling the second metal contact to a second input of the leak detection circuit.

18. The method of claim 17, wherein the first metal contact is formed of a different material then the second metal contact.

19. The method of claim 18, wherein the presence of the coolant liquid creates a galvanic potential between the first metal contact and the second metal contact that is detected by the leak detection circuit.

20. A liquid coolant connection collar to couple a first element of a liquid cooling system to a second element of the liquid cooling system, the liquid coolant connection collar comprising:
an inner wall configured to seal the coolant liquid from leaking;
a first metal contact surrounding the inner wall;
an isolator surrounding the first metal contact; and
a second metal contact surrounding the isolator;
wherein the liquid coolant connection collar is configured to provide an electrical input to a leak detection circuit in the presence of a coolant liquid leak from the liquid coolant connector collar.
